(19) United States
(12) Patent Application Publication
(10) Pub. No.: US 2026/0124912 A1
(43) Pub. Date: May 7, 2026

(54) SPEED CONTROL SYSTEM FOR AN AGRICULTURAL MACHINE

(71) Applicant: Deere & Company, Moline, IL (US)

(72) Inventor: Kevin J. Goering, Cambridge, IA (US)

(21) Appl. No.: 18/934,550

(22) Filed: Nov. 1, 2024

(51) Int. Cl. B60K 31/00; A01B 76/00

(52) U.S. Cl. CPC B60K 31/00; A01B 76/00

(57) ABSTRACT

A method for controlling the speed of an agricultural machine operating within an environment. The method includes obtaining at least one machine-specific parameter associated with the agricultural machine, determining at least one operating condition of the agricultural machine, and determining at least one environmental condition of the environment. The method further includes determining a target speed for the agricultural machine based on the at least one machine-specific parameter, the at least one operation condition, and the at least one environmental condition, and adjusting the speed of the agricultural machine to the target speed.

### TECHNICAL FIELD

This disclosure relates to agricultural machines, and more particularly, to a speed control system for an agricultural machine.

### BACKGROUND

Traditional agricultural machines may rely heavily on operator input for speed control. The operator may be required to constantly monitor various factors, such as terrain conditions, weather, and crop conditions, to maintain a safe and efficient speed.

Speed control systems may be implemented in agricultural machines to decrease the operator input for the speed control. Such speed control systems may utilize one or more sensors of the agricultural machines to monitor movement of the agricultural machines. For example, the agricultural machines may include one or more sensors that monitor the engine load and/or ground speed of the agricultural machines to determine control to ensure the speed of the agricultural machines is within an acceptable range. Due at least in part to such speed control systems, agricultural machines may operate substantially or entirely autonomously without the need for operator input (e.g., manual speed control by the operator).

### SUMMARY

In one aspect of the present disclosure, a method for controlling a speed of an agricultural machine operating within an environment is disclosed. The method includes obtaining at least one machine-specific parameter associated with the agricultural machine, determining at least one operating condition of the agricultural machine, and determining at least one environmental condition of the environment. The method also includes determining a target speed for the agricultural machine based on the at least one machine-specific parameter, the at least one operation condition, and the at least one environmental condition, and adjusting the speed of the agricultural machine to the target speed.

In some configurations, the at least one machine-specific parameter may include at least one of a wheelbase of the agricultural machine or a center of gravity of the agricultural machine. At least one of the wheelbase or the center of gravity changes during operation of the agricultural machine.

In some configurations, the at least one operating condition may include at least one of a current speed of the agricultural machine, a maximum possible speed of the agricultural machine, a position of the agricultural machine, an orientation of the agricultural machine, a ride quality of the agricultural machine, a load of the agricultural machine, or a mechanical issue of the agricultural machine.

In some configurations, the at least one operating condition may include a power capacity of the agricultural machine. The power capacity may be associated with an ability of the agricultural machine to increase speed or decrease speed to reach the target speed.

In some configurations, the at least one operating condition may include an off-track error that may be determined based on a distance between a current position of the agricultural machine and a desired position of the agricultural machine along a pre-defined path of the agricultural machine.

In some configurations, the at least one environmental condition may include at least one of a terrain feature or a weather condition. The terrain feature may include at least one of bumpiness of a terrain of the environment, a slope of the terrain, or a curvature of the terrain. The weather condition may include at least one of precipitation, wind, visibility, temperature, or sunlight.

In some configurations, determining the target speed may be further based on historical operating data associated with the agricultural machine or another agricultural machine in the environment.

In some configurations, determining the target speed may be further based on a terrain map corresponding to the environment.

In some configurations, the method may further include determining at least one of a location or a speed of an additional agricultural machine within the environment. The target speed may be further based on at least one of the location or the speed of the additional agricultural machine.

In some configurations, the method may further include obtaining at least one of a maximum allowable speed or a minimum allowable speed. The target speed may be at or below the maximum allowable speed and at or above the minimum allowable speed.

In another aspect of the present disclosure, a system for controlling a speed of an agricultural machine operating within an environment is disclosed. The system includes one or more memories and one or more processors. The one or more processors are configured to execute instructions stored in the one or more memories. The one or more processors are configured to execute instructions stored in the one or more memories to obtain at least one machine-specific parameter associated with the agricultural machine, determine at least one operating condition of the agricultural machine, and determine at least one environmental condition of the environment. The one or more processors are also configured to execute instructions stored in the one or more memories to determine a target speed for the agricultural machine based on the at least one machine-specific parameter, the at least one operation condition, and the at least one environmental condition, and adjust the speed of the agricultural machine to the target speed.

In some configurations, the at least one machine-specific parameter may include at least one of a wheelbase of the agricultural machine or a center of gravity of the agricultural machine, and wherein at least one of the wheelbase or the center of gravity changes during operation of the agricultural machine.

In some configurations, the at least one operating condition may include at least one of a current speed of the agricultural machine, a maximum possible speed of the agricultural machine, a position of the agricultural machine, an orientation of the agricultural machine, a ride quality of the agricultural machine, a load of the agricultural machine, or a mechanical issue of the agricultural machine.

In some configurations, the at least one operating condition may include a power capacity of the agricultural machine. The power capacity may be associated with an ability of the agricultural machine to increase speed or decrease speed to reach the target speed.

In some configurations, the at least one environmental condition may include at least one of a terrain feature or a weather condition. The terrain feature may include at least one of bumpiness of a terrain of the environment, a slope of the terrain, or a curvature of the terrain. The weather condition may include at least one of precipitation, wind, visibility, temperature, or sunlight.

In some configurations, the one or more processors may be further configured to execute instructions stored in the one or more memories to determine at least one of a location or a speed of an additional agricultural machine within the environment. The target speed may be further based on at least one of the location or the speed of the additional agricultural machine.

In some configurations, the one or more processors may be further configured to execute instructions stored in the one or more memories to obtain at least one of a maximum allowable speed or a minimum allowable speed. The target speed may be at or below the maximum allowable speed and at or above the minimum allowable speed.

In another aspect of the present disclosure, one or more non-transitory computer readable media storing instructions operable to cause one or more processors to perform operations is disclosed. The instructions are operable to cause the one or more processors to perform operations to control a speed of an agricultural machine operating within an environment. The operations include obtaining at least one machine-specific parameter associated with the agricultural machine, determining at least one operating condition of the agricultural machine, and determining at least one environmental condition of the environment. The operations also include determining a target speed for the agricultural machine based on the at least one machine-specific parameter, the at least one operation condition, and the at least one environmental condition, and adjusting the speed of the agricultural machine to the target speed.

In some configurations, the at least one operating condition and the at least one environmental condition may be based on data obtained by one or more sensors of the agricultural machine. The one or more sensors may include at least one of a Global Positioning System (GPS) sensor, an Inertial Measurement Unit (IMU) sensor, a light detection and ranging (LiDAR) sensor, and a camera.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a side view of an example of a machine that includes a speed control system.

FIG. 1B is another side view of the machine shown in FIG. 1A.

FIG. 1C is a top-down view of the machine shown in FIG. 1A.

FIG. 2A is a top-down view of a machine that includes a speed control system during operation.

FIG. 2B is another top-down view of the machine shown in FIG. 2A in communication with another machine.

FIG. 3 is a diagram of an example of a speed control system of a machine.

FIG. 4 is a flowchart of a first example of a technique for operating a machine using a speed control system.

FIG. 5 is a flowchart of a second example of a technique for operating a machine using a speed control system.

FIG. 6 is a flowchart of a third example of a technique for operating a machine using a speed control system.

FIG. 7 is a flowchart of a fourth example of a technique for operating a machine using a speed control system.

### DETAILED DESCRIPTION

The present disclosure relates to a speed control system for use with various machinery, providing a cost-effective and accurate way of controlling the speed of the machinery during operation. The speed control system may be configured for use with agricultural machinery, construction equipment, automotive vehicles, or other types of machinery. By way of example, the speed control system may be configured for use with agricultural machinery, such as a planter machine configured to plant various seeds or a sprayer machine configured to apply one or more products (e.g., nutrients, fertilizers, pesticides, soil amendments, water, or growth regulators) to various crops.

The speed control system may be configured to monitor and/or control the speed of the machinery being operated (e.g., agricultural machinery). The speed control system may detect objects, movement, environmental conditions, machinery conditions (e.g., operating conditions), or a combination thereof, which may be analyzed to determine a target speed of the machinery. For example, the speed control system may include (e.g., include, work in conjunction with, or be associated with) one or more sensors. The one or more sensors may be reactive (e.g., configured to react to a particular change in the machinery, such as movement, motion, load, etc.) and/or proactive (e.g., configured to actively monitor the machinery and/or an environment surrounding the machinery). One or more of the sensors may, for example, each be an image sensor (e.g., a camera) that may be configured to capture images and/or videos within a field of view (e.g., within a field of view of a lens of a respective sensors that includes the image sensor), may be configured to detect environmental conditions (e.g., weather conditions, terrain features, etc.), may be configured to detect operating conditions of the machinery (e.g., movement of the machinery, orientation of the machinery, a load of the machinery, etc.), or a combination thereof.

The speed control system may include proximity sensors that may be configured to detect obstacles of other machinery nearby; acoustic sensors that may be configured to identify machinery and/or environmental anomalies through sound analysis; operational sensors that may be configured to detect and/or measure operating conditions of the machinery (e.g., movement of the machinery, machinery degradation, fuel levels, speed, GPS location, etc.); other types or sensors; or a combination thereof.

Conventional systems for speed control in agricultural machinery may rely on operator input. Operators may be responsible for adjusting speed based on factors like terrain, curves, and other environmental conditions (e.g., weather conditions). Such conventional systems may also include basic safety mechanisms, such as disengaging automated guidance if the machine deviates from its planned path or encounters difficulty maintaining control. Such safety mechanisms may require further operator input to reactivate autonomous operation of the agricultural machinery.

The reliance on operator input for speed control in conventional systems may have limitations. For example, a significant burden is placed on the operator, who must constantly monitor and/or adjust the agricultural machine's speed to ensure safe and efficient operation. This can lead to operator fatigue and potential errors, especially under challenging or unpredictable environmental conditions, such as rough terrain or adverse weather. Additionally, conventional systems for speed control in agricultural machinery may be unable to respond quickly or effectively enough to sudden changes in terrain or other factors (e.g., weather conditions), increasing the risk of accidents or damage to the agricultural machine. For example, if the agricultural machine encounters a rough spot (e.g., a severely degraded spot in the terrain) or a washout, the operator may not be able to react in time to prevent the agricultural machine from becoming unstable or disengaging from its semi-automated speed control system. This can lead to delays, reduced productivity, and potential safety hazards.

Implementations according to this disclosure solve problems such as these by providing a speed control system that does not rely on the operator. For example, the speed control system may provide automated speed control of an agricultural machine using various sensors that may be used alone or in combination. The speed control system may monitor the agricultural machine to detect deviation of the agricultural machine from a planned travel path. Based on sensor data captured by the sensors, the speed control system may identify ground roughness (e.g., bumpiness), may monitor the ride quality of the agricultural machine, may detect various weather conditions (e.g., precipitation (e.g., rain, snow, etc.), wind, fog, sunlight, etc.), or a combination thereof, and adjust the speed of the agricultural machine accordingly.

Additionally, the speed control system may utilize one or more terrain maps to identify terrain features (e.g., bends, bumpiness, elevation changes, etc.) and adjust the speed of the agricultural machine based on the terrain features. Moreover, the speed control system may receive user input (e.g., operator input) to specify a maximum and/or minimum allowable speed for the agricultural machine. Furthermore, the speed control system may communicate with other machinery in the surrounding area of the agricultural machine to adjust the speed of the agricultural machine based upon operating conditions (e.g., a current position, speed, travel path, et.) of the other machinery.

Thus, the speed control system described herein may maximize productivity by increasing the speed of the agricultural machine when conditions allow, and decreasing the speed to prevent accidents and/or damage, when necessary. Moreover, the speed control system may communicate with other machinery and/or analyze past operating data to further improve the effectiveness and the efficiency of the agriculture machine.

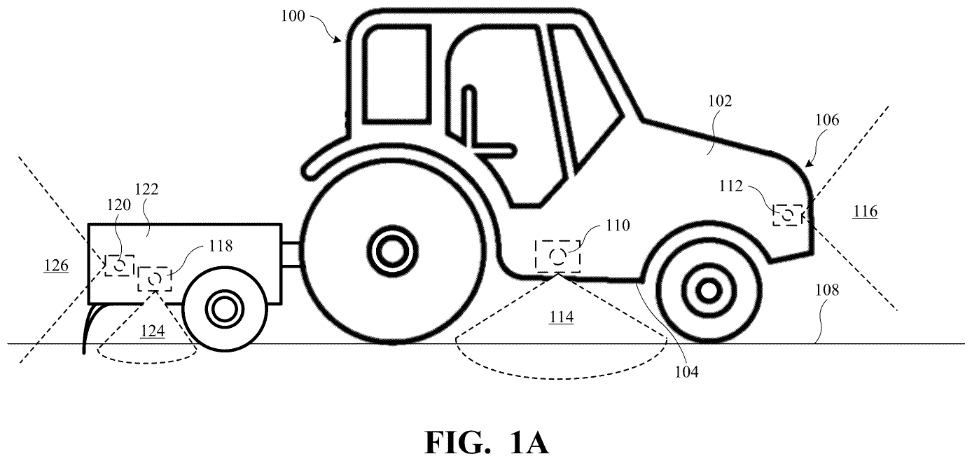

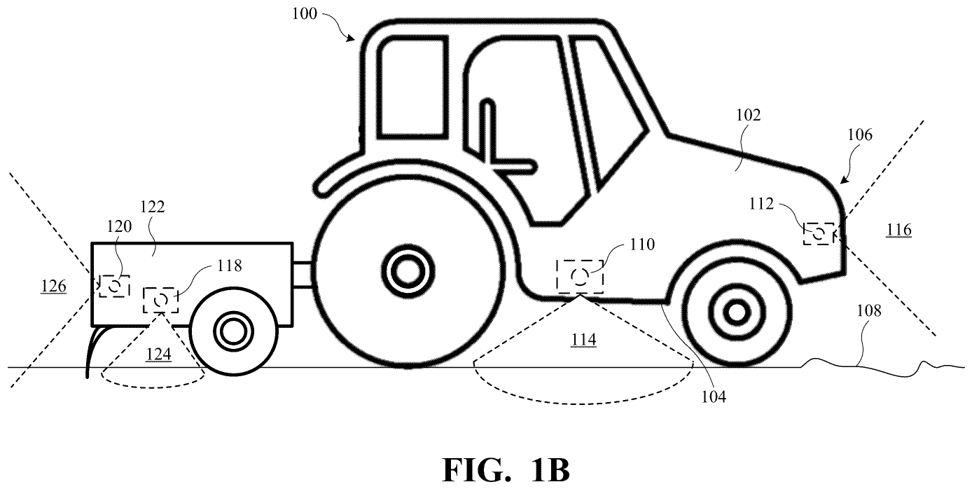

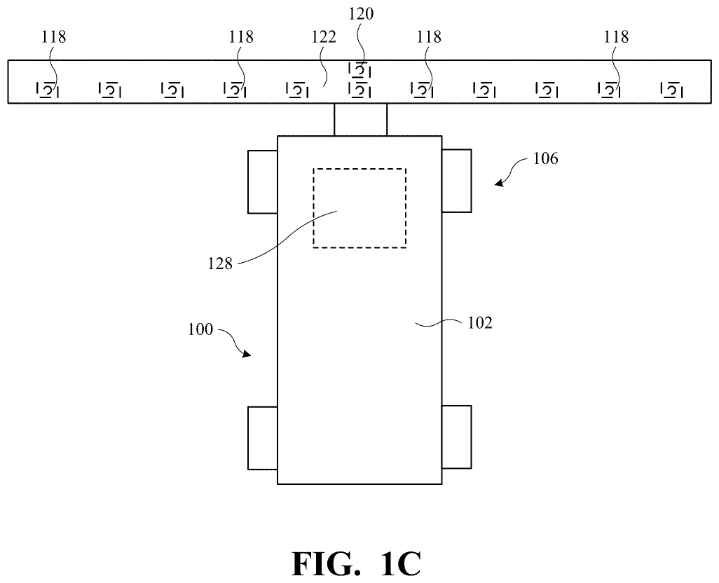

Turning now to the figures, FIGS. 1A and 1B illustrate side views of a machine 100 in accordance with the present teachings. The machine 100 may include a body 102 and a frame 104. The frame 104 may form part of the body 102 or may support the body 102 of the machine 100. Additionally, the machine may include a speed control system. As discussed above, the machine 100 is not limited to any specific type of machinery. For example, the machine 100 may be a vehicle, equipment, other object, or a combination thereof. The machine 100 may be configured for operation in any type of industry, including agriculture, horticulture, or other types of industry. By way of example, as shown in FIGS. 1A and 1B, the machine 100 may be an agriculture machine, such as a tractor or applicator that is configured to traverse a terrain 108 to apply one or more products (e.g., fertilizer, nutrients, fungicide, pesticide, etc.) to crops or a combine configured to harvest the crops. In some configurations, the agriculture machine may be remotely and/or autonomously operated such that an operator need not be present at the location of the agriculture machine.

A speed control system 106 may be coupled to or part of the machine 100 so that one or more sensors of the speed control system 106, such as a first sensor 110 and a second sensor 112, may be positioned to monitor or otherwise interact with an area around the machine 100. For example, the first sensor 110 may be coupled (e.g., connected, mounted, secured, etc.) to the body 102 or the frame 104. Thus, a field of view 114 of the first sensor 110 (e.g., a field of view of a lens of the first sensor 110) may extend outboard with respect to the machine 100 along the ground beneath the machine 100. The second sensor 112 may also be coupled to the body 102 or the frame 104 such that a field of view 116 (e.g., a field of view of a lens of the second sensor 112) may extend outboard with respect to the machine 100 in front of the machine 100 (e.g., in a forward direction of travel of the machine 100).

Alternatively, or additionally, the speed control system 106 may be coupled to an accessory or secondary component of the machine 100. For example, as shown in FIGS. 1A and 1B, the speed control system 106 may include a third sensor 118 and a fourth sensor 120 coupled to a trailer 122 of the machine 100. The trailer 122 may be connected to the machine 100 so that the trailer 122 may, for example, be towed or pushed by the machine 100. For example, the trailer 122 may be an applicator that is configured to apply water, nutrients, fertilizer, pesticides, fungicides, or a combination thereof to the crops. As such, the third sensor 118 may be positioned along an exterior surface of the trailer 122 so that a field of view 124 of the third sensor 118 (e.g., a field of view of a lens of the third sensor 118) may extend outboard with respect to the trailer 122 along the ground beneath the trailer 122. The fourth sensor 120 may also be coupled to the trailer 122 such that a field of view 126 (e.g., a field of view of a lens of the fourth sensor 120) may extend outboard with respect to the trailer 122 behind the trailer 122 (e.g., in a rearward direction of travel of the machine 100).

It should be noted that the speed control system 106 may include any number of sensors (e.g., zero or more of the first sensor 110, zero or more of the second sensor 112, zero or more of the third sensor 118, zero or more of the fourth sensor 120, one or more additional sensors, etc.) and may be positioned in any desired manner by adjusting the mounting of the speed control system 106 to the machine 100 and/or to the trailer 122. That is, an overall field of view, which may include the field of view 114 of the first sensor 110, the field of view 116 of the second sensor 112, the field of view 124 of the third sensor 118, the field of view 126 of the fourth sensor 120, or a combination thereof, may be configured to capture any desired region(s) around the machine 100, which may include parts or components of the machine 100 and/or the trailer 122, surrounding crops, the terrain 108 surrounding the machine 100 and/or the trailer 122, or a combination thereof.

By way of example, the machine 100 may be coupled to the trailer 122 to drive the trailer 122, whereby the trailer 122 may be an applicator configured to apply a topical spray to existing crops within a field, such as a pesticide or fertilizer. In this configuration, the speed control system 106 may be integrated into the machine 100 and/or the trailer 122 so that the field of view 114 of the first sensor 110 and the field of view 124 of the third sensor 118 can monitor the terrain 108 beneath the machine 100 and/or the trailer 122. Additionally, the speed control system 106 may be coupled to the machine 100 and/or the trailer 122 so that the field of view 116 of the second sensor 112 can monitor the area (including the terrain 108) ahead of the machine 100 and the trailer 122, and the field of view 126 of the fourth sensor 120 can monitor the area (including the terrain 108) behind the machine 100 and the trailer 122. The sensors (e.g., the first sensor 110, the second sensor 112, the third sensor 118, and the fourth sensor 120) may be positioned to monitor various environment-related parameters (e.g., sensor data associated with the terrain 108, associated with the weather, associated with other objects in area around the machine 100 and/or the trailer 122, etc.) and/or monitor operation of the machine 100 (e.g., sensor data associated with the operation of the machine 100). The sensors (e.g., respective image sensors of the sensors) may capture the sensor data associated with the environment and/or the machine 100, which may then be evaluated by the speed control system 106 (e.g., by a control module therein) to determine a target speed in which to operate the machine.

For example, the sensors may capture the sensor data associated with the terrain 108 and the speed control system 106 may analyze the captured sensor data to determine whether to increase or decrease the speed of the machine 100. As shown in FIG. 1A, the terrain 108 ahead of the machine 100 (e.g., within the field of view 116 of the second sensor 112) may be a substantially flat and even surface. As a result, the speed control system 106 (e.g., the control module therein) may determine that a target speed of the machine 100 is greater than a current operating speed of the machine 100, and thus increase the speed of the machine 100 to reach the target speed. Conversely, as shown in FIG. 1B, the terrain 108 ahead of the machine 100 (e.g., within the field of view 116 of the second sensor 112) may be substantially uneven and bumpy. As a result, the speed control system 106 (e.g., the control module therein) may determine that a target speed of the machine 100 is less than the current operating speed of the machine 100, and thus decrease the speed of the machine 100 to reach the target speed.

FIG. 1C illustrates a top-down view of the machine 100 and the trailer 122 shown in FIGS. 1A and 1B. As discussed above, the speed control system 106 may include more than one of the first sensor 110, more than one of the second sensor 112, more than one of the third sensor 118, more than one of the fourth sensor 120, or a combination thereof. In certain configurations, the speed control system 106 may not include the first sensor 110, the second sensor 112, the third sensor 118, the fourth sensor 120, or a combination thereof.

By way of example, FIG. 1C illustrates an array of the third sensors 118. The array includes a plurality of the third sensor 118, which may extend along substantially the entire width of the trailer 122, as measured transverse to a direction of travel of the machine 100 and the trailer 122 during operation. Each of the sensors of the array of the third sensors 118 may include a field of view that may be similar to the field of view 124 shown in FIGS. 1A and 1B. As a result, the array of the third sensors 118 (e.g., image sensors thereof) may capture data (e.g., data associated with the environment and/or data associated with operation of the machine 100) in a surrounding area that extends along the width of the trailer 122.

Additionally, in some implementations, the trailer 122 may be configured to adjust its width to accommodate various crop widths. As described above, the trailer 122 may be an applicator that is configured to apply a topical spray to existing crops within a field, such as a pesticide or fertilizer. A width of the trailer 122 (e.g., as measured transverse to the direction of travel of the machine 100) may be adjusted (e.g., increased or decreased) based upon a row width of the existing crops within the field such that the trailer 122 extends to or beyond the row width of the existing crops to apply the topical spray to the crops. In such a case, the third sensor 118 and/or the fourth sensor 120 may capture data associated with adjusting the width of the trailer 122.

The captured data may then be evaluated by the speed control system 106. For example, the captured data may be initially transmitted from the third sensors 118 to a control module 128 of the speed control system 106. In such a case, the control module 128 may evaluate the captured data to determine whether a speed of the machine 100 should be increased or decreased.

It should be noted that, while the trailer 122 is described in detail above, implementation of the speed control system 106 is not limited to the trailer 122. By way of example, the speed control system 106 may be implemented on self-propelled machinery, such as a self-propelled sprayer or applicator, a self-propelled combine, or a self-propelled cart (e.g., grain cart). For example, the speed control system 106 may include one or more sensors that may be positioned along a boom of the self-propelled machinery such that the one or more sensors may be positioned on at least one of a front portion, a rear portion, one or more side portions, a top portion, and a bottom portion of the machinery (e.g., on the boom of the machinery). As such, the speed control system 106 may be configured to monitor a direction of travel of the machinery or other directions transverse to the direction of travel of the machinery to determine a target speed in which to operate the machinery.

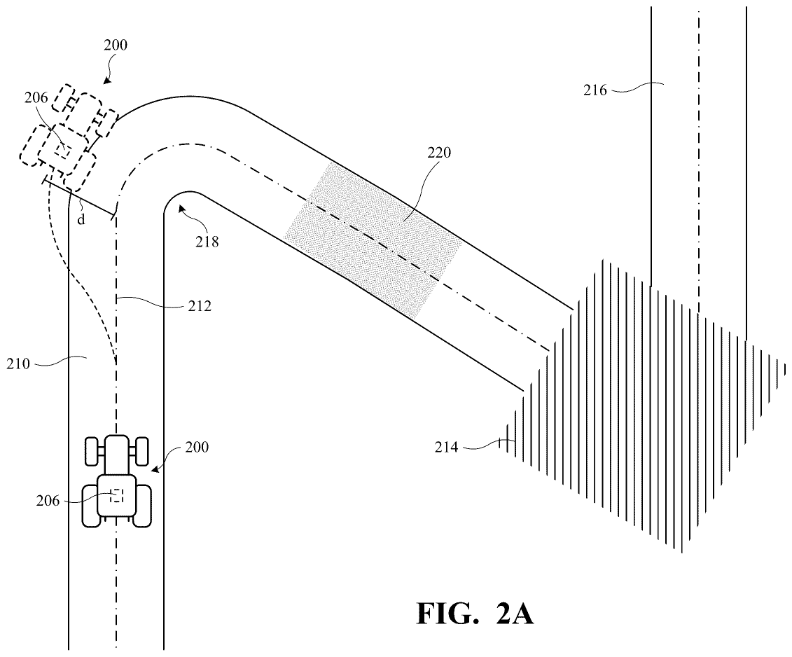

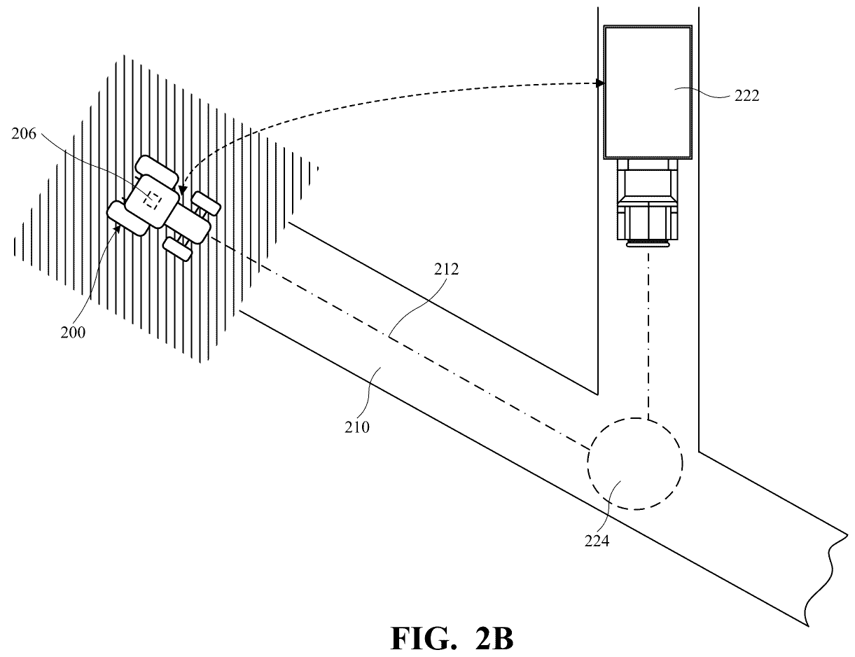

FIGS. 2A and 2B illustrate a top-down view of a machine 200 that includes a speed control system 206. The speed control system can be the speed control system 106 of FIGS. 1A-1C. The speed control system 206 may be configured to control a speed of the machine 200 during operation of the machine 200. For example, the speed control system 206 may be configured to monitor and adjust the speed of the machine 200 during operation, such as during autonomous driving of the machine 200 along a path 210.

The speed control system 206 may monitor and capture data (e.g., data associated with the environment and/or data associated with operation of the machine 200) in an area surrounding the machine 200. By way of example, the speed control system 206 may include or be associated with one or more sensors (e.g., the first sensor 110, the second sensor 112, the third sensor 118, and/or the fourth sensor 120) to analyze data captured by the sensors that is associated with environmental conditions in the surrounding area and/or associated with operating conditions of the machine 200. For example, the speed control system 206 may determine: environmental conditions, such as terrain features (e.g., bumpiness of the terrain, a slope of the terrain, curvature of the terrain, anomalies of the terrain, etc.) and weather conditions (e.g., precipitation, wind, visibility issues caused by sunlight or fog, temperature, etc.); and operating conditions of the machine 200, such as a current speed, a maximum possible speed, a position of the machine 200, an orientation of the machine 200, a ride quality (e.g., high vibration versus low or no vibration), and a load (e.g., a weight) of the machine 200. The captured data may then be analyzed by the speed control system 206 to increase and/or decrease the speed of the machine 200. That is, the speed of the machine 200 may be increased and/or decreased by the speed control system 206 based upon the environmental conditions and/or the operating conditions.

In an example, the sensors of or associated with the speed control system 206 may capture data associated with environmental conditions in the surrounding area and may capture data associated with operating conditions of the machine 200. For example, the speed control system 206 may include one or more gyroscopes that capture data (i.e., captured sensor data) associated with rotation of the machine 200 with respect to one or more axes of rotation. The captured sensor data may be analyzed by the speed control system 206 to determine the angular velocity of the machine 200 about the one or more axes of rotation. The speed control system 206 may then determine at least one of a bumpiness, slope, and curvature of the terrain. For example, the speed control system 206 may define an angular velocity value range that corresponds to flat (e.g., level) terrain. If the angular velocity determined by the speed control system 206 falls within the angular velocity value range, the speed control system 206 may determine that the terrain is flat. Thus, the speed control system 206 may determine that the current speed of the machine 200 may be increased safely or should remain the same given the current terrain conditions. However, if the angular velocity value is greater or less than the threshold angular velocity value range, the speed control system 206 may determine that the machine 200 is traveling uphill or downhill, respectively. In such a case, the speed control system 206 may determine that the current speed of the machine 200 should be increased (e.g., when traveling uphill) or decreased (e.g., when traveling downhill) to traverse the terrain.

In another example, the speed control system 206 may include one or more image sensors (e.g., a camera) and one or more accelerometers. The image sensors may be configured to capture images of the terrain, and the speed control system 206 may analyze the captured images to detect terrain features. For example, the speed control system 206 may utilize one or more image processing techniques (e.g., edge detection, texture analysis, color analysis, etc.) to analyze the captured images and compare the captured images with expected or known features (e.g., expected or known features of the terrain based on terrain maps obtained by the speed control system 206). Based on such a comparison, the speed control system 206 may determine one or more features of the terrain, such as objects (e.g., structures), bumpiness of the terrain, washouts, ruts, or other changes in the terrain.

Additionally, the one or more accelerometers may be configured to capture data (i.e., captured sensor data) associated with vibration of the machine 200 by capturing changes in motion (e.g., measurements of accelerations and decelerations) of the machine 200. These changes in motion may then be converted into electrical signals, which may then be further analyzed by the speed control system 206. For example, the speed control system 206 may define a vibration threshold value and compare the measurements of acceleration and deceleration to the vibration threshold value. If the measurements of acceleration and deceleration are greater than the vibration threshold value, the speed control system 206 may determine that the ride quality of the machine 200 is unacceptable (e.g., bumpy). In such a case, the speed control system 206 may determine that the speed of the machine 200 should be decreased to minimize the overall vibration of the machine 200. Conversely, if the measurements of acceleration and deceleration are less than the vibration threshold value, the speed control system 206 may determine that the ride quality of the machine 200 is acceptable (e.g., smooth). In such a case, the speed control system 206 may determine that the speed of the machine 200 should remain the same or be increased since the current vibration of the machine 200 is minimal.

In another example, the speed control system 206 may include one or more sensors (e.g., strain gauge sensors, pressure sensors, ultrasonic sensors, load cells, accelerometers, etc.) that are configured to determine a load (e.g., weight) of the machine 200. By way of example the speed control system 206 may include one or more strain gauge sensors coupled to a structure (e.g., an axel or suspension system) of the machine 200. The strain gauge sensors may measure strain or deformation of the structure. These strain or deformation measurements may then be obtained and analyzed by the speed control system 206. For example, the speed control system 206 may store or obtain a predefined load (e.g., weight) of the machine 200 without any additional load (e.g., additional load from crops, debris, users, etc.). The speed control system 206 may analyze the strain or deformation measurements to determine how much additional load (e.g., weight) above the predefined weight of the machine 200 would result in such strain or deformation of the structure of the machine 200, and thus determine the current load (e.g., weight) of the machine 200. For example, the machine 200 may be carrying additional materials (e.g., fertilizer, tools, etc.) and the speed control system 206 may determine that the current load (e.g., weight) of the machine 200 is greater than the predefined load. In such a case, the speed control system 206 may determine that a braking distance of the machine 200 is decreased and/or stress on tires of the machine 200 is increased. Thus, the speed of the machine 200 should be decreased.

As discussed herein, the speed control system 206 may be configured to adjust the speed of the machine 200. That is, based on the captured sensor data as described above, the speed control system 206 may determine a target speed for the machine 200 and increase or decrease the current speed of the machine 200 to reach the target speed. For example, the control module (e.g., the control module 128 of the speed control system 206 analyze the captured sensor determine and determine the target speed. The control module of the speed control system 206 may then communicate directly or indirectly (e.g., via another control module of the machine 200, such as a control module of a guidance system of the machine 200) with the machine 200 to increase or decrease the speed of the machine 200. For example, the control module of the speed control system 206 may communicate with an electronic control unit (ECU) of the machine 200 to adjust the engine throttle to increase or decrease the power output of the engine of the machine 200 and/or to adjust a transmission ratio of the transmission of the machine 200. Such adjustments may in turn increase or decrease the speed of the machine 200.

To further illustrate operation of the speed control system 206, FIG. 2A will now be described in further detail. As shown in FIG. 2A, the machine 200 is configured to operate (e.g., drive or otherwise advance) along the path 210. The machine 200 may be autonomously operated using a guidance system of the machine 200 such that operator input is minimal or not needed. For example, the machine 200 may include a guidance system that uses one or more sensors, which may include some or all of the sensors of the speed control system, to autonomously drive the machine 100 along a desired route 212 (e.g., a route determined by the guidance system to direct the machine 200 along the path 210) to reach a destination point, such as the field 214 or a destination point beyond the field 214 (e.g., a destination point along the second path 216). As shown in FIG. 2A, the desired route 212 may advance the machine 200 along the path 210 through one or more environmental conditions, such as: one or more curves (e.g., bends or banks), such as the curve 218; uneven (e.g., bumpy, undulating, rocky, etc.) terrain, such as the terrain 220; and elevation changes along the path 210 (e.g., hills and/or valleys).

While it may be desirable for the guidance system of the machine 200 to maintain a position of the machine 200 along the desired route 212, the curve 218, the terrain 220, elevation changes, or a combination thereof may hinder the guidance system from doing so alone. For example, the guidance system may establish the desired route 212 yet be unable to account for such environmental conditions along the desired route 212, thereby resulting in the machine 200 veering off-course (e.g., off the desired route 212), as illustrated by the machine 200A shown in dashed lines in FIG. 2A that veered off the desired route 212 and followed the deviating route 212A instead. In such a situation, the guidance system may conventionally disable autonomous operation and require operator input to correct the off-track error (i.e., the deviation of the machine 200 from the desired route 212) or even stop the machine 200 altogether.

To help prevent disabling of the autonomous operation, the speed control system 206 may be part of, or communicate with, the guidance system. The speed control system 206 may communicate with the guidance system to monitor the environmental conditions and/or the operating conditions to determine a target speed for the machine 200. The speed control system 206 may then adjust the speed of the machine 200 (i.e., the operating speed) to match the target speed.

By way of example, the guidance system may operate the machine 200 at a predefined speed along the desired route 212. However, the predefined speed may be too fast for the machine 200 to safely traverse through the curve 218 and/or through the terrain 220 to reach the field 214. In such a case, the speed control system 206 may monitor and capture data associated with the surrounding area to adjust the speed of the machine 200 to safely travel along the desired route 212 to reach the field 214. For example, the speed control system 206 may detect that the machine 200 is nearing the curve 218 and/or nearing the terrain 220. Moreover, the speed control system 206 may monitor a distance (d) between a current position of the machine 200 and the desired route 212 (i.e., monitor an off-track error of the machine 200, as illustrated by broken lines in FIG. 2A). Based upon the machine 200 nearing the curve 218, nearing the terrain 220, deviating from the desired route 212, or a combination thereof, the speed control system 206 may decrease the speed of the machine 200 to ensure that the machine 200 safely and efficiently continues along or proximal to the desired route 212 to reach the field 214.

As discussed above, the speed control system 206 may monitor the distance (d) between a current position of the machine 200 and the desired route 212. By way of example, the speed control system may include a Global Positioning System (GPS) sensor that is configured to receive signals from GPS satellites to calculate a location of the machine 200. The machine 200 may also include the guidance system, which may be configured to create a pre-defined path or trajectory (e.g., the desired route 212). The pre-defined path or trajectory may be generated from data obtained from the GPS sensor, terrain maps, or other guidance data. Based on such a configuration, the speed control system 206 may then compare the actual position of the machine 200, which may be determined using the GPS or data captured by the sensors of the speed control system 206 (e.g., by inertial measurement unit sensors of the speed control system 206), to the desired position of the machine 100 along the pre-defined path or trajectory (e.g., the desired route 212). The difference between the actual position and the desired position of the machine 100 may correspond to the distance (d), which may represent how far the machine 100 has deviated from the pre-defined path or trajectory (i.e., an off-track error). For example, the desired position of the machine 100 may be a minimum distance (d) between the actual position and the pre-defined path or trajectory.

The distance (d) may then be evaluated by the speed control system 206 to determine whether the speed of the machine 100 should be increased or decreased. For example, the speed control system 206 may define a threshold distance value. The distance (d) between the actual position and the desired position of the machine 100, as described above, may be compared to the threshold distance value. If the distance (d) above the threshold distance value, the speed control system 206 may determine that the machine 200 is deviating too far from the pre-defined path or trajectory (e.g., the desired route 212) and may further determine that the speed of the machine 200 should be decreased to allow for the machine 200 (e.g., the guidance system of the machine 200) to correct its course back towards the pre-defined path or trajectory. Conversely, if the distance (d) is below the threshold distance value, the speed control system 206 may determine that the machine 200 is traveling sufficiently close to the pre-defined path or trajectory (e.g., the desired route 212) and may further determine that the speed of the machine 200 should remain constant.

In another example, the guidance system may operate the machine 200 at a predefined speed along the desired route 212. However, one or more objects (e.g., additional machinery, people, structures, etc.) may be located along or near (e.g., within a predefined distance from) the desired route 212. In such a case, the predefined speed may be too fast for the machine 200 to safely travel along the desired route 212 without impacting the one or more objects. Similarly, in circumstances where the one or more objects are located on the desired route 212, the predefined speed may be too fast to safely route the machine 200 around the one or more objects (e.g., to safely route the machine 200 along an alternative route that deviates from the desired route 212 to avoid impacting the one or more objects). As a result, the speed control system 206 may monitor and capture data associated with the surrounding area to adjust the speed of the machine 200 to avoid impacting the one or more objects. For example, the speed control system 206 (e.g., one or more sensors, such as image sensors (e.g., cameras) of the speed control system 206) may detect the one or more objects along and/or near the desired route 212 adjust the speed of the machine 200 accordingly. By way of example, if an object is located on the desired route 212 in front of the machine 200 with respect to a direction of travel of the machine, the speed control system 206 (e.g., one or more sensors, such as image sensors (e.g., cameras) of the speed control system 206) may detect the object and determine that the speed of the machine 200 should be decreased to safely guide the machine 200 around the object (e.g., along the alternative route) and/or stop the machine 200 to prevent impact with the object. Similarly, if an object is located near the desired route 212 (e.g., within a predefined distance away from the machine 200 when traveling along the desired route 212), the speed control system 206 may determine that a speed of the machine 200 should be decreased until the object is safely passed.

The speed control system 206 may also obtain one or more machine-specific parameters associated with the machine 200 to more accurately determine the target speed. While the operating conditions and the environmental conditions may be determined using data captured by the speed control system 206 during operation (e.g., movement) of the machine 200, the machine-specific parameters may be parameters associated with the machine 200. For example, the speed control system 206 may obtain machine-specific parameters, such as a wheelbase, a center of gravity, a weight, or other parameters associated with the machine 200, prior to operation (e.g., movement) of the machine 200. The machine-specific parameters may then also be utilized to determine the target speed of the machine 200, in addition to the environmental conditions and/or the operating conditions.

By way of example, the speed control system 206 may obtain the wheelbase and the center of gravity of the machine 200 prior to operation of the machine 200. The speed control system 206 may determine a turn radius of the machine 200 based upon the wheelbase of the machine 200. For example, the speed control system 206 may obtain the wheelbase of the machine 200 and may retrieve a corresponding turn radius of the machine 200 from locally stored data (e.g., data stored on a memory of the speed control system 206) and/or may retrieve the turn radius from a remote server. The speed control system 206 may then determine the target speed based upon the turn radius and the center of gravity of the machine 200. For example, the speed control system 206 may define a maximum allowable speed of the machine 200 based upon the turn radius and the center of gravity to prevent the machine 200 from flipping or going off-track. The speed control system 206 may then determine a target speed that is at or below the maximum allowable speed. Additionally, as described with respect to FIG. 1C, the wheelbase and/or the center of gravity of the machine 200 may dynamically change (e.g., based upon extension and/or contraction of a boom of the machine 200, based upon a load of the machine 200 (e.g., based upon additional weight associated with crop, applicator solution, etc.)), based upon other factors, etc.) In such a case, the speed control system 206 may adjust the target speed based upon the changes in wheelbase and/or the center of gravity (e.g., to adjust the maximum allowable speed of the machine 200).

The machine 200 (e.g., the speed control system 206 therein) may also be configured to communicate with additional machinery, such as the additional machine 222 shown in FIG. 2B. Such communication is illustrated by the dashed arrow extending therebetween. The machine 200 may communicate with the additional machine 222 to synchronize movement between the machine 200 and the additional machine 222. By way of example, the machine 200 may communicate with the additional machine 222 an expected (e.g., estimated) time and/or location that the machine 200 will complete its operation. For example, the machine 200 may be a combine traveling along the desired route 212 to harvest crops on the path 210. The machine 200 may be in communication with the additional machine 222, which may be a grain cart, to communicate when and where the machine 200 will be at capacity. For example, the machine 200 may communicate to the additional machine 222 that the machine 200 will be at capacity at a location 224 at a specified time. Based on such communication, the additional machine 222 (e.g., the grain cart) may be configured to arrive at the location 224 to meet the additional machine 222 (e.g., the combine) at the specified time.

In another example, the machine 200 may be a grain cart and the additional machine 222 may be a combine that communicates a location (e.g., the location 224) and time of completion to the machine 200 in which the additional machine 222 will complete its operation (e.g., harvesting) and require the machine 200 (e.g., to unload the harvested crops). In such a case, the speed control system 206 of the machine 200 may determine the location of the machine (e.g., via GPS) and determine the distance (e.g., via GPS) to the location. The speed control system 206 may then determine (e.g., calculate) a speed required to reach the location at the time of completion of the additional machine 222. In such a case, the speed control system 206 may more accurately determine a time of arrival of the machine 200 at the location (and/or a speed required to reach the location by determining operating condition(s) and/or environmental condition(s). For example, if the speed control system 206 determines that it is currently raining and the terrain is bumpy, the speed control system 206 may accordingly adjust (e.g., increase) a time of arrive to account for such conditions. Similarly, the speed control system 206 may further determine that the machine 200 is unable to safely operate at the speed required to reach the location by the time of completion of the additional machine 222 and may thereby determine a maximum allowable speed of the machine 200 that is less than the speed required to reach the location by the time of completion of the additional machine 222. Such determinations may also be communicated to the additional machine 222 such that the additional machine 222 may adjust its operation (e.g., speed) accordingly.

Similarly, the additional machine 222 may also communicate to the machine 200 a location, speed, or other operating conditions, associated with the additional machine 222. The target speed determined by the speed control system 206 of the machine 200 may thus be further based on the operating conditions of the additional machine 222. For example, the machine 200 may communicate that the location 224 is the expected location that the machine 200 will complete its operation at the expected time. The additional machine 222 may then communicate its speed and/or distance from the location 224 to the machine 200 so that the speed control system 206 may adjust the speed of the machine 200 such that the machine 200 and the additional machine 222 arrive at the location 224 at substantially the same time. That is, the speed control system 206 may determine a target speed based at least in part on the speed and/or the distance from the location 224 communicated by the additional machine 222, and the current speed of the machine 200 may be increased or decreased to reach the target speed.

The additional machine 222 may be manually operated (e.g., manually driven) and/or autonomously operated. For example, the additional machine 222 may have a guidance system similar to the guidance system of the machine 200 described above. Moreover, the additional machine 222 may also include a speed control system that is similar or the same as the speed control system 206. Thus, the speed of the additional machine 222 may also be adjusted based on at least one of environmental conditions, operating conditions (e.g., operating conditions of the additional machine 222 and/or operating conditions of the machine 200 communicated to the additional machine 222), and predefined conditions associated with the additional machine 222 (e.g., wheelbase, center of gravity, etc.).

Any group or type of machinery may be in communication with one another for speed control and/or guidance as described herein. In the above example where the machine 200 may be a combine and the additional machine 222 may be a grain cart, the machine 200 and/or the additional machine 222 may be in communication with other machinery to further optimize overall operation and/or synchronization of the machinery. For example, the machine 200 and/or the additional machine 222 may be in communication with any number of other machinery, such as other tractors, trucks, applicators (e.g., sprayers), weeders, harvesters, or other machines. Thus, the teachings herein are not particularly limited to the machine 200 and the additional machine 222 described above.

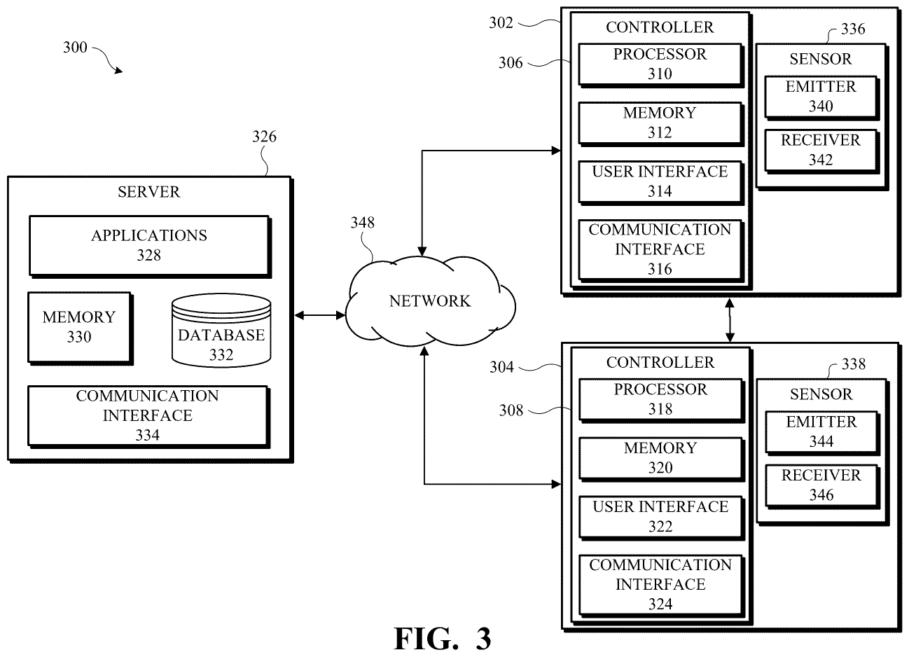

To describe some implementations of the speed control systems described herein, FIG. 3 is a diagram of an example of a system 300 to further illustrate the electronic computing and communication of the speed control systems described herein. For example, the system 300 may include a speed control system 302, which may be or may be similar to the speed control system 106 shown in FIGS. 1A-1C or the speed control system 206 shown in FIGS. 2A and 2B. The system 300 may also include an additional speed control system 304, which may be in communication with the speed control system 302. For example, the additional speed control system 304 may be a speed control system of the additional machine 222 shown in FIG. 2B.

The system 300 may include one or more computing devices, such as a controller 306 of the speed control system 302, a controller 308 of the additional speed control system 304, or both. The controller 306 is shown as including a processor 310, a memory 312, a user interface 314, and a communication interface 316. Similarly, the controller 308 is shown as including a processor 318, a memory 320, a user interface 322, and a communication interface 324. The description herein of the processor 310, the memory 312, the user interface 314, and the communication interface 316 may is applicable to the processor 318, the memory 320, the user interface 322, and the communication interface 324, respectively, unless otherwise stated. The controllers 306, 308 may facilitate communication between machinery, such as between the machine 200 and the additional machine 222 of FIGS. 2A and 2B. For example, the controllers 306, 308 may facilitate communication between the speed control system 302 and the additional speed control system 304. The controllers 306, 308 may also facilitate communication between the machinery and a server 326. As shown, the server 326 may include applications 328, a memory 330, a database 332, and a communication interface 334.

The speed control system 302 may include one or more sensors, such as a first sensor 336. The additional speed control system 304 may also include one or more sensors, such as a second sensor 338. The first sensor 336 and the second sensor 338 may be or may be similar to the first sensor 110, the second sensor 112, the third sensor 118, and the fourth sensor 120 of the speed control system 106 shown in FIGS. 1A-1C. The first sensor 336 may be, may be similar to, or different from, the second sensor 338. By way of example, the first sensor 336 may include an emitter 340 and a receiver 342, and the second sensor 338 may include an emitter 344 and a receiver 346 that are similar to the emitter 350 and the receiver 342, respectively. The first sensor 336 and the second sensor 338 may be image sensors (e.g., cameras) such that the emitters 340, 344 may transmit light to a portion of a terrain (e.g., the terrain 108) within a respective field of view of the each of the image sensor modules. The light may reflect off the terrain within the respective fields of view and be captured by the receivers 342, 346 in the form of one or more images. The captured image(s) may be further evaluated to determine one or more environmental conditions associated with the terrain, such as by identifying distinct reflectance patterns, determining one or more reflectance values based upon the captured image(s), and calculating one or more parameters based upon the determined reflectance value(s). Such evaluation may be completed by the controllers 306, 308. Any image processing techniques may be implemented by the controllers 306, 308 to evaluate the image(s).

The first sensor 336 and the second sensor 338 may be any type of sensor. For example, the first sensor 336 and/or the second sensor 338 may be any type of imaging sensor, such as a multispectral camera, a visible light camera, a near-infrared camera, an ultraviolet (UV) camera, a thermal camera, or some other type of camera. The first sensor 336 and/or the second sensor 338 may also be a Global Positioning System (GPS) sensor, an Inertial Measurement Unit (IMU) sensor (e.g., an accelerometer, a gyroscope, a magnetometer, a pressure sensor, a temperature sensor, etc.), a light detection and ranging (LiDAR) sensor, or other type of sensor.

The processors 310, 318 may be a microprocessor and may include a single processor or multiple processors. A processor may have a single processing core or multiple processing cores. The processors 310, 318 may be or include other types of devices, or multiple devices, not existing or hereafter developed, configured for manipulating or processing information. The controllers 306, 308 may include multiple processors interconnected in one or more manners, including but not limited to, hardwired or networked (e.g., wirelessly networked). By way of example, the operations of the processor 310 may be distributed across multiple devices or units that may be coupled directly or via a local area or other suitable network. The processors 310, 318 may also include a cache or cache memory for local storage of operating data or instructions associated with the evaluation.

The memory 312, 320 may include one or more memory components, which may each be volatile memory or non-volatile memory. For example, the volatile memory of the memory 312 may be random access memory (RAM) (e.g., a DRAM module, such as DDR SDRAM) or another form of volatile memory. In another example, the non-volatile memory of the memory 312 may be a disk drive, a solid-state drive, flash memory, phase-change memory, or another form of non-volatile memory configured for persistent electronic information storage. The memory 312, 320 may also include other types of devices, now existing or hereafter developed, configured for storing data or instructions for processing by the processors 310, 318.

The memory 312, 320 can include data for immediate access by the controllers 306, 308. For example, the memory 312 may include executable instructions, application data, an operating system, or a combination thereof accessible by the processor 310. The executable instructions, the application data, the operating system, or a combination thereof may be loaded or copied, in whole or in part, from non-volatile memory to volatile memory to be executed by the controller 306. For example, the executable instructions and application data may include instructions and data for, as described herein, determining a target speed of a machine; determining when to adjust (e.g., increase or decrease) a current speed of the machine to reach the target speed; determine one or more environmental conditions (e.g., weather conditions, terrain features, etc.) and/or one or more operating conditions of the machine (e.g., load, orientation, position, speed, etc.); and overall machine control. As such, the memory 312, 320 may include executable instructions that, when executed by the processors 310, 318, facilitate the performance of or perform the techniques described herein.

The memory 312, 320 may include executable instructions or application data associated with a respective one of the communication interfaces 316, 324. The communication interfaces 316, 324 may be or may include a transmitter and/or a receiver. The communication interfaces 316, 324 may facilitate communication between, for example, a machine and a speed control system (e.g., the speed control system 302 and/or the additional speed control system 304). For example, the communication interfaces 316, 324 may enable data exchange over a communication path allowing for real-time synchronization and data updates between the machine and the speed control system.

The user interfaces 314, 322 may include one or more input interfaces and/or output interfaces. An input interface may be, for example, a positional input device, such as a mouse, touchpad, touchscreen, or the like; a keyboard; or another suitable human or machine interface device. An output interface may be, for example, a display, such as a liquid crystal display, a cathode-ray tube, a light emitting diode display, or other suitable display. As such, an operator may interact with speed control system software, input a maximum allowable speed and/or a minimum allowable speed, view real-time data related to the speed control system(s) (e.g., data associated with current operation of the machine, data associated with the terrain around the machine, etc.), and monitor the status of the speed control system(s) through the user interfaces 314, 322. Additionally, the user interfaces 314, 322 may provide visual indicators and alerts to assist the operator (i.e., the user) in maintaining optimal system operation and synchronization.

The controllers 306, 308 may include additional components. For example, the controllers 306, 308 may include power management units, various sensors for monitoring environmental conditions and machine status, and interfaces for connecting to external storage devices or other peripherals (e.g., the server 326). These components may ensure that the controllers 306, 308 operate reliably in various agricultural environments and can handle the processing and communication demands of the speed control systems.

The speed control system 302, the additional speed control system 304, and the server 326 may be in communication via a network 348. The network 348 may be or may include, for example, the Internet, a local area network (LAN), a wide area network (WAN, a virtual private network (VPN), or another public or private means of electronic computer communication capable of transferring data between the controller 306 of the speed control system 302, the controller 308 of the additional speed control system 304, and the server 326. In some implementations, an operator, via the user interface 314 and/or the user interface 322, may connect to the network 348 via a communal connection point, link, or path, or using a distinct connection point, link, or path. For example, a connection point, link, or path can be wired, wireless, use other communications technologies, or a combination thereof. Additionally, it should be noted that the speed control system 302, the additional speed control system 304, and the server 326 may include network hardware such as routers, switches, other network devices, or a combination thereof.

The speed control system 302 and/or the additional speed control system 304 may communicate with the server 326 via the network 348. For example, the communication interface 316 of the controller 306 and/or the communication interface 324 of the controller 308 may communicate with the communication interface 334 of the server 326 to access data stored in the memory 330 or the database 332, to access one or more of the applications 328, or both. The memory 330 may be similar to the memory 312, 320 described above.

The database 332 may store any data associated with the machinery and/or the speed control systems. For example, the database 332 may store machine-specific parameters (e.g., predefined parameters) associated with the machinery, such as a wheelbase or a center of gravity of the machine; historical operating data associated with the machinery (e.g., data associated with operation of the machinery within a similar region); terrain maps corresponding to the environment in which the machinery is currently operating; and other data relevant to operating the machinery using the speed control systems. The database 332 may thus be accessed by the speed control systems to obtain data that may be used to determine the target speed(s) of the machinery.

The applications 328 of the server 326 may be one or more applications run (e.g., executed) on the server 326. The applications may provide an interface for the speed control systems to access portions of the server 326. For example, the applications 328 may include a an application that facilitates access to the memory 330 and/or the database 332 by the speed control systems to retrieve historical operation data (described further below) associated with the machinery.

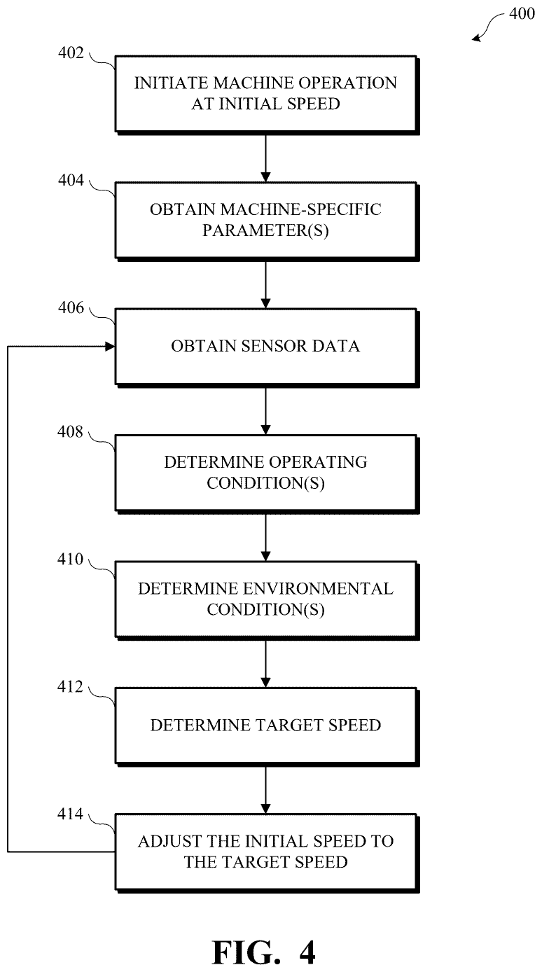

To further describe some implementations in greater detail, reference is next made to examples of techniques which may be performed by or using a speed control system to operator a machine. FIG. 4 is a flowchart of a first example of a technique 400 for operating a machine using a speed control system. The technique 400 may be executed using computing devices, such as the systems, hardware, and software described with respect to FIGS. 1A-3. The technique 400 can be performed, for example, by executing by a processor, such as the processor 310 of FIG. 3, a machine-readable program or other computer-executable instructions, such as routines, instructions, programs, or other code, and which may be stored in a memory such as the memory 312 of FIG. 3. The steps, or operations, of the technique 400, or another technique, method, process, or algorithm described in connection with the implementations disclosed herein can be implemented directly in hardware, firmware, software executed by hardware, circuitry, or a combination thereof. The technique 400 can be executed by a speed control system, such as the speed control system 106 of FIGS. 1A-1C, the speed control system 206 of FIGS. 2A and 2B, or the speed control system 302 of FIG. 3.

For simplicity of explanation, the technique 400 is depicted and described herein as a respective series of steps or operations. However, the steps or operations of the technique 400 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 402, machine operation is initiated at an initial speed. That is, a current speed of the machine is set to the initial speed. The machine is operated to reach the initial speed based on an acceleration parameter. For example, the speed control system may communicate with an electronic control unit (ECU) of the machine 100. The speed control system may determine the acceleration parameter (e.g., an acceleration rate) needed to reach the initial speed within a desired (e.g., predefined) period of time and communicate such acceleration parameter to the ECU. The acceleration parameter may be determined by the speed control system based upon one or more other machine-related parameters, such as the current speed of the machine, a load (e.g., weight or mass) of the machine, engine characteristics (e.g., engine power, torque curves, etc.), and other factors. The speed control system and/or the ECU may then control the machine's throttle (e.g., the throttle of an engine of the machine) and/or transmission gear ratios to accelerate the machine based upon the acceleration parameter to reach the initial speed. The speed control system may monitor the acceleration of the machine based upon analyzing data captured by one or more sensors of the speed control system (e.g., accelerometer measurements, GPS-based speed measurements via a GPS sensor of the machine, wheel-speed sensor measurements, etc.) to determine whether the machine reaches the initial speed.

In an example, the speed control system may initiate operation of the machine. The speed control system may commence the operations of the machine at a default speed, which may be predefined by the speed control system and/or the guidance system or may be input by an operator.

Once operation of the machine is initiated, the speed control system may obtain one or more machine-specific parameters, at 404. For example, the speed control system may obtain one or more machine-specific parameters, such as a wheelbase or a center of gravity of the machine, from a remote server (e.g., the server 326 of FIG. 3), a control module of the machine ), or another device. In certain implementations, the speed control system may store the machine-specific parameter(s) locally (e.g., within a memory of the speed control system) such that, when machine operation is initiated, the speed control system may locally access such machine-specific parameter(s). In certain implementations, an operator may manually input the machine-specific parameter(s), such as via a user interface of the speed control system and/or a user interface of the machine (e.g., a display of the machine). It should also be noted that one or more machine-specific parameters may be adjusted before, during, or after operation of the machine. By way of example, the wheelbase and/or the center of gravity may dynamically change during operation of the machine. For example, the machine may be a spreader that automatically adjusts its wheelbase to accommodate various widths of crop fields. As a result, both the wheelbase and the center of gravity of the machine may change, which may be in turn communicated to the speed control system to adjust the machine-specific parameter(s).

After the machine-specific parameters are obtained, the speed control system may obtain sensor data, at 406. In an example, the sensor data may be data obtained by one of more sensors of (e.g., included in or associated with) the speed control system. The one or more sensors may be similar to any of the sensors described above with respect to FIGS. 1A-3.

Once the sensor data is obtained, the speed control system may determine one or more operating conditions associated with the machine, at 408. That is, the speed control system may utilize the sensor data to determine the operating condition(s). The operating condition(s) may be or include: a current speed of the machine; a maximum possible speed of the machine (e.g., calculated based upon a current load of the machine, the terrain, weather, etc.); a position of the machine; an orientation of the machine; a ride quality of the machine (e.g., determine a bumpiness of a ride using an IMU or sensors thereof); a load of the machine (e.g., based upon a weight of crop currently being stored in the machine), a power capacity of the machine (e.g., an ability of the machine to increase and/or decrease speed based upon other operating conditions and/or environmental conditions); an off-track error of the machine (e.g., a distance in which the machine deviates from an intended route, such as a desired route predetermined by a guidance system of the machine); mechanical issues of the machine (e.g., low tire pressure, overheating of the engine, fuel leak, axel and/or bearing failure, difficulty shifting, engine belt degradation or tearing, etc.); and other operating conditions.

Once the operation conditions are determined, the speed control system may determine one or more environmental conditions, at 410. That is, the speed control system may utilize the sensor data to determine the environmental condition(s). The environmental condition(s) may be or include a terrain feature, such as: the bumpiness of the terrain in which the machine is traversing (e.g., the bumpiness of terrain in front of the machine with respect to a direction of travel of the machine); a slope of the terrain (e.g., an increase and/or a decrease in elevation, such as a hill or a drop-off); curvature of the terrain (e.g., a bend or bank along a path of travel of the machine); anomalies in the terrain (e.g., ruts, beds, washouts, etc.); and other terrain features. The environmental condition(s) may also or alternatively be or include a weather condition, such as precipitation (e.g., rain, snow, hail, etc.), wind, visibility (e.g., visibility issues caused by fog and/or sunlight), temperature, debris in the air, and other weather conditions. The environmental condition(s) may further be or include detection of objects in the environment, such as a structure (e.g., building, fence, silo, etc.), other machines, animals, or people.

Once the environmental conditions are determined, the speed control system may utilize the sensor data to determine the target speed, at 412. That is, the target speed may be determined based upon one or more of the machine-specific parameter(s), the operating condition(s), and the environmental condition(s). In an example, the speed control system may determine that the current ride quality of the machine is acceptable (e.g., smooth), the terrain is substantially flat and not bumpy, and the weather is fair (e.g., no rain or wind).

By way of example, the speed control system may include one or more accelerometers and one or more image sensors (e.g., cameras). The accelerometer(s) may detect and measure linear acceleration and/or deceleration of the machine in one or more directions (e.g., vertical movement and/or lateral movement of the machine with respect to a direction of travel). Additionally, the image sensor(s) may capture images of the terrain in front of the machine with respect to the direction of travel. The speed control system may analyze the data captured by the sensors of the speed control system (e.g., the measurements of the accelerometer(s) and the images captured by the image sensor(s) to determine the above conditions (e.g., the ride quality, bumpiness of the terrain, and weather conditions).

For example, as discussed above, the speed control system may define a threshold value such that, if one or more of the measurements of the accelerometer(s) exceeds the threshold value, the speed control system may determine that the amount of vibration of the machine is unacceptable and thus the ride quality of the machine is unacceptable (e.g., bumpy). Conversely, if one or more of the measurements of the accelerometer(s) is below the threshold value, the speed control system may determine that the amount of vibration is minimal (e.g., negligible), and thus the ride quality of the machine is acceptable (e.g., smooth). Similarly, the speed control system may define one or more value ranges associated with the measurements of the accelerometer such that the speed control system may determine a level of bumpiness of the terrain. For example, the speed control system may define three value ranges: high, medium, and low. Based upon which value range one or more of the measurements of the accelerometer is within, the speed control system may determine the level of bumpiness of the terrain (e.g., high, medium, low).

Moreover, the speed control system may analyze the images captured by the image sensor(s) to determine one or more weather conditions. For example, the speed control system may utilize one or more image processing techniques (e.g., edge detection, texture analysis, color analysis, etc.) to analyze the captured images of the environment (e.g., the terrain) and determine whether it is currently raining and/or whether debris is currently present in the air (e.g., due to wind). For example, the speed control system may compare the captured images to expected or know images (e.g. baseline images) to identify any color changes within the image and determine whether such color changes are correlated to an environmental condition (e.g., rain and/or debris present). In an example, the speed control system may identify that the color of the terrain, such as along the path of the machine, is substantially darker than a baseline image. As a result, the speed control system may determine that the darker color is a result rain.

Turning back to the above example, the speed control system may determine, using techniques such as those described above, that the current ride quality of the machine is acceptable (e.g., smooth), the terrain is substantially flat and not bumpy, and the weather is fair (e.g., no rain or wind). Thus, the speed control system may determine, based on such conditions, that the machine may safely operate at an increased speed (e.g., a speed greater than the current (e.g., initial) operating speed of the machine). Therefore, the speed control system may determine that the target speed should be greater than the current operating speed of the machine (e.g., greater than the current speed).

Conversely, in another example, the speed control system may determine, using techniques such as those described above, that the current ride quality of the machine is unacceptable (e.g., too much vibration), the terrain is rocky (e.g., bumpy), and it is currently raining. In such a case, the speed control system may determine, based on such conditions, that the machine cannot safely operate at its current speed (e.g., the current speed). Therefore, the speed control system may determine that the target speed should be less than the current operating speed (e.g., the current speed).

Once the target speed is determined, the current speed of the machine may be adjusted by the speed control system to the target speed at 414. That is, the current operating speed of the machine may be increased or decreased to reach the target speed and continue operation of the machine at the target speed.

By way of example, the speed control system may analyze at least one of the machine-specific parameter(s), the operating condition(s), and the environmental condition(s) to determine the target speed (e.g., a value of the target speed). For example, speed control system may obtain the target speed from a database (e.g., the database 332 of FIG. 3), which may be associated with a particular combination of machine-specific parameter(s), operating condition(s), and environmental condition(s). In the above example, the speed control system may determine, utilizing the techniques described above, that the current ride quality of the machine is unacceptable (e.g., too much vibration), the terrain is rocky (e.g., bumpy), and it is currently raining. This particular combination of conditions may correspond to a first target speed stored within the database. Conversely, the speed control system may determine that the current ride quality of the machine is acceptable, the terrain is substantially flat, and it is currently not raining. In such a case, this combination of conditions may correspond to a second target speed stored within the database, which may be the same or different from the first target speed. Thus, any number of target speeds may be stored within the database based upon a given combination of conditions.

In addition to, or in lieu of accessing the database to obtain the target speed, the speed control system may calculate the target speed utilizing the at least one of the machine-specific parameter(s), the operating condition(s), and the environmental condition(s). For example, each of the machine-specific parameter(s), the operating condition(s), and the environmental condition(s) may be assigned a value (e.g., a weight), which may be input into the calculation for the target speed. Such calculation is not particularly limited to any one formula. Additionally, such calculation may be based upon any number of the machine-specific parameters, the operating conditions, the environmental conditions, or a combination thereof. For example, the speed control system may calculate the target speed utilizing a single condition (e.g., a single machine-specific parameter, a single operating condition, or a single environmental condition) or more than one of the above-mentioned conditions.

In the above example, the speed control system may determine, using the above techniques, that the current ride quality is unacceptable, the terrain is bumpy, and it is raining. In such a case, the speed control system may assign a value (e.g., weight) to each of the ride quality, the terrain quality (e.g., bumpiness), and the rain. For example, each of the ride quality, the terrain quality (e.g., bumpiness), and the rain may be assigned a weight that decreases the overall target speed determined to account for potentially dangerous conditions. That is, the target speed calculated by the speed control system may be less than the current speed (e.g., the initial speed) such that the speed of the machine may be decelerated from the current speed to the target speed (e.g., using an acceleration factor, such as those described above).

Once the machine is operating at the target speed, the speed control system may continuously or intermittently (e.g., based upon a predefined time interval) obtain sensor data (i.e., additional or new sensor data) at 406 to determine additional or new operating condition(s) and/or additional or new environmental condition(s). Thus, the speed control system may actively monitor operation of the machine to dynamically adjust the speed of the machine and ensure safe operation of the machine.

It should be noted that the speed control system may also determine more than one possible target speed based upon one or more of the machine-specific parameter(s), the operating condition(s), and the environmental condition(s). That is, the speed control system may determine more than one possible target speed based upon a subset of the machine-specific parameter(s), the operating condition(s), and the environmental condition(s). The speed control system may then select one of the possible target speeds as and assign it as the target speed.

In an example, the speed control system may determine a first possible target speed based upon a first subset of conditions (e.g., one or more of the machine-specific parameter(s), the operating condition(s), and the environmental condition(s)) and a second possible target speed based upon a second subset of conditions (e.g., a machine-specific parameter, an operating condition, or an environmental condition). For example, the first possible target speed may be based upon a machine-specific parameter, such as a wheelbase or a center of gravity of the machine, and an environmental condition, such as upcoming curvature (e.g., a turn) of a path being traveled by the machine. The first possible target speed may correspond to a maximum speed in which the machine is able to operate safely through the curvature without flipping. The maximum speed in which the machine may operate safely through the curvature without flipping (i.e., the first possible target speed) may be calculated using one or more formulas and the aforementioned conditions as inputs for the one or more formulas. Additionally, the second possible target speed may be based upon an operating condition, such as a load (e.g., weight) of the machine, and an environmental condition, such as the bumpiness of the terrain. The second possible target speed may be associated with an acceptable stopping distance (e.g., a safe stopping distance) of the machine. For example, a safe stopping distance may be predefined by the speed control system or may be determined based upon one or more of the conditions, such as the load of the machine and/or the bumpiness of the terrain. In such a case, the speed control system may determine a speed of the machine (i.e., the second possible target speed) in which the machine may be able to successfully stop within the acceptable stopping distance. The speed control system may then select the lower (e.g., minimum) value between the first possible target speed and the second possible target speed and assign such value as the target speed (e.g., the determined target speed).

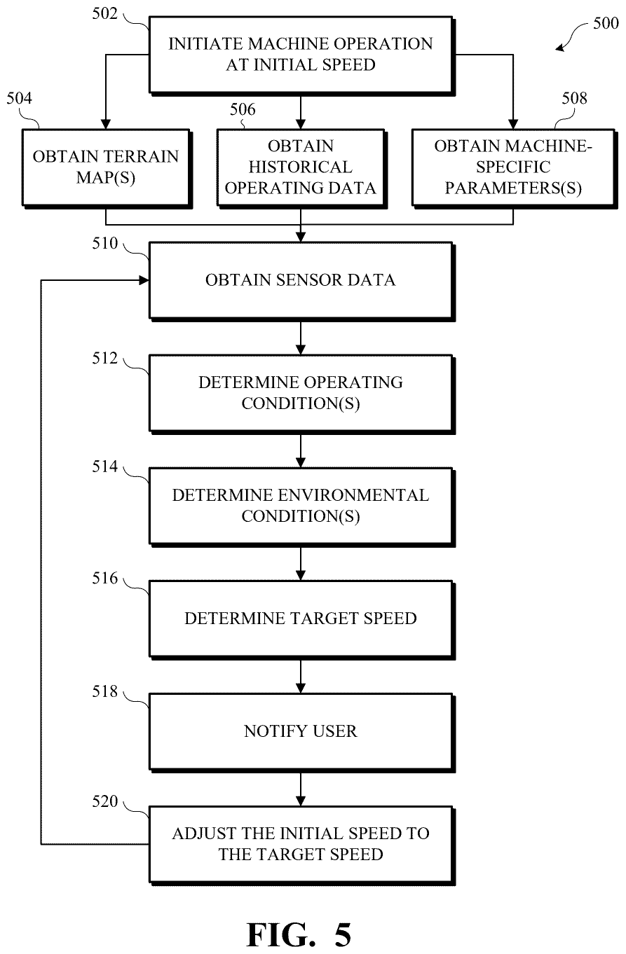

FIG. 5 is a flowchart of a second example of a technique 500 for operating a machine using a speed control system. The technique 500 may be executed using computing devices, such as the systems, hardware, and software described with respect to FIGS. 1A-3. The technique 500 can be performed, for example, by executing a by a processor, such as the processor 310 of FIG. 3, a machine-readable program or other computer-executable instructions, such as routines, instructions, programs, or other code, and which may be stored in a memory such as the memory 312 of FIG. 3. The steps, or operations, of the technique 500, or another technique, method, process, or algorithm described in connection with the implementations disclosed herein can be implemented directly in hardware, firmware, software executed by hardware, circuitry, or a combination thereof. The technique 500 can be executed by a speed control system, such as the speed control system 106 of FIGS. 1A-1C, the speed control system 206 of FIGS. 2A and 2B, or the speed control system 302 of FIG. 3.

For simplicity of explanation, the technique 500 is depicted and described herein as a respective series of steps or operations. However, the steps or operations of the technique 500 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 502, machine operation is initiated at an initial speed. That is, a current speed of the machine is set to the initial speed. The machine is operated to reach the initial speed based on an acceleration parameter, such as the acceleration parameter described above with respect to the technique 400 of FIG. 4. In an example, the speed control system may initiate operation of the machine. The speed control system may commence the operations of the machine at a default speed, which may be predefined by the speed control system and/or the guidance system or may be input by an operator.

Once operation of the machine is initiated, the speed control system may obtain one or more terrain maps at 504, historical operating data at 506, and one or more machine-specific parameters at 508. The speed control system may obtain one or more of the terrain map(s), historical operating data, and machine-specific parameter(s) from a remote server (e.g., the server 326 of FIG. 3), a control module of the machine, or another device. In certain implementations, the speed control system may store one or more of the terrain map(s), the historical operating data, and the machine-specific parameter(s) locally (e.g., within memory of the speed control system) such that, when the operation is initiated, the speed control system may locally access such information. The machine-specific parameter(s) may be the same as or similar to the machine-specific parameters discussed above with respect to the technique 400 shown in FIG. 4. The speed control system may obtain one or more of the terrain map(s), the historical operating data, and the machine-specific parameter(s). For example, in an implementation, the speed control system may only obtain historical operating data and the machine-specific parameter(s), but not any terrain maps.

The terrain map(s) may be associated with the environment (e.g., the terrain) in which the machine is currently operating. The terrain map(s) may include: topography, elevation, natural features (e.g., landforms, hydrography, vegetation, etc.), manufactured features (e.g., roads, paths, trails, buildings, structures (e.g., bridges, silos, fences, etc.)), boundaries (e.g., property boundaries), and other information.

The historical operating data may be any data associated with previous operations of the machine or other machinery. The historical operating data may include previous operations of the machine or other machinery within the current environment (e.g., on the same terrain) or another environment. By way of example, the machine may be a combine that is configured to harvest one or more crops within a region. The historical operating data may be or may include data associated with previous harvests by the machine in the region. For example, the historical operating data may include: a travel path of the machine; a speed of the machine; a load (e.g., weight) of the machine; run time; production output (e.g., total volume of crop harvested); operating parameters (e.g., temperature, feed rate, tire pressure, etc.); energy consumption (e.g., electricity and/or fuel usage over time); environmental data associated with the previous operations (e.g., temperature, precipitation, etc.); and other operating data.

The historical operating data may also include data recorded by the machine (e.g., by the speed control system) and stored locally on the machine (e.g., stored locally within a memory of the speed control system, such as the memory 312 of FIG. 3) and/or stored remotely from the machine (e.g., stored remotely on a server, such as the server 326 of FIG. 3). For example, during operation of the machine, the speed control system may obtain data from sensors to determine (e.g., identify) one or more of anomalies (e.g., objects, ruts, washouts, etc.), terrain features (e.g., bumpy areas of the terrain, elevation changes, etc.), or other areas of interest. Such anomalies, terrain features, and other areas of interest may be stored locally on the machine (e.g., stored locally within the memory of the speed control system) and/or stored remotely from the machine (e.g., stored remotely on the server). As a result, the machine and/or additional machinery may retrieve such information for current and/or subsequent operations.

After the terrain map(s), the historical operating data, and the machine-specific parameter(s) are obtained, the speed control system may obtain sensor data, at 510. In an example, the sensor data may be data obtained by one of more sensors of (e.g., included in or associated with) the speed control system.

Once the sensor data is obtained, the speed control system may determine one or more operating conditions associated with the machine, at 512. The operating condition(s) may be the same as or similar to the operating conditions discussed above with respect to the technique 400 shown in FIG. 4.

Once the operating conditions are determined, the speed control system may determine one or more environmental conditions, at 514. The environmental condition(s) may be the same as or similar to the environmental conditions discussed above with respect to the technique 400 shown in FIG. 4.

Once the environmental conditions are determined, the speed control system may determine a target speed, at 516, in the same or similar manner described with respect to FIG. 4 (e.g., obtaining the target speed from a database and/or calculating the target speed) utilizing the data obtained from the terrain map(s), the historical operating data, the machine-specific parameter(s), and the sensor(s). The target speed may be determined based upon one or more of the terrain map(s), the historical operating data, the machine-specific parameter(s), the operating condition(s), and the environmental condition(s).

In an example, the speed control system may determine that the terrain is substantially flat based upon the terrain map(s) and/or historical operating data. For example, the speed control system may compare a current position of the machine, which may be obtained using GPS, to a corresponding position of the machine within the terrain map(s) and/or the historical operating data to determine a bumpiness of the terrain. The terrain map(s) and/or historical operating data may include data associated with the bumpiness of the terrain for the current position of the machine, which may then be obtained by the speed control system. In such a case, the speed control system may determine, that the machine may safely operate at a speed that is greater than the current speed of the machine. Therefore, the speed control system may determine that the target speed should be greater than the current operating speed of the machine (e.g., the current speed).

Conversely, in an example, the speed control system may determine that the terrain is bumpy based upon the terrain map(s) and/or historical operating data. For example, the speed control system may compare the current position of the machine, which may be obtained using GPS, to a corresponding position of the machine within the terrain map(s) and/or the historical operating data to determine that the terrain is bumpy. As described above, the terrain map(s) and/or the historical operating data may include data associated with the bumpiness of the terrain for the current position of the machine, which may then be obtained by the speed control system. In such a case, the speed control system may determine that the machine may not safely operate at the current speed of the machine. Therefore, the speed control system may determine that the target speed should be less than the current operating speed of the machine (e.g., the current speed).

Once the target speed is determined, a user (e.g., an operator) may be notified, at 518, of various information associated with operation of the machine. The operator may be physically present on or in the machine or the operator may be remotely located. In instances where the operator is located on or in the machine, the user may be notified via a user interface of the speed control system (e.g., the user interface 314), a user interface of the machine, an external device, or a combination thereof. In instances where the operator is located remote from the machine, the user may be notified via an external device (e.g., a computer, tablet, smartphone, etc.) The notifications provided to the user are not particularly limited. For example, the user may be notified that a target speed has been determined, of a delta (e.g., a difference) between the target speed and the current speed, that a speed of the machine will subsequently (e.g., within a predefined number of seconds or minutes (e.g., within 10 seconds)) be adjusted to match the target speed, of other machine-related information, or a combination thereof.

Based upon such user notification, the user may manually intervene with the operation of the machine. For example, when the user is notified that a target speed has been determine and/or that a speed of the machine will subsequently (e.g., within a predefined duration of time) be adjusted to match the target speed, the user may manually accept and/or reject the speed adjustment. For example, the user may accept the speed adjustment by manually inputting the acceptance via a user interface (e.g., the user interface 314 of FIG. 3) or refraining from any manual input via the user interface. Conversely, the user may reject the speed adjustment by manually inputting the rejection via the user interface to prevent the machine from adjusting its current operating speed and/or stopping the machine altogether. Additionally, or alternatively, the user may override the determined target speed and manually provide (e.g., via the user interface) an alternative target speed such that the speed control system may adjust the current speed of the machine to match the alternative target speed. While user notification is described herein with respect to FIG. 5, similar user notification may be implemented in any of the techniques and/or speed control systems shown in FIGS. 1A-7.

Once the user is notified, the current speed of the machine may be adjusted (e.g., after acceptance of the target speed by the user) by the speed control system to the target speed, at 520. The current speed of the machine may be adjusted based upon an acceleration parameter (e.g., the acceleration parameter of FIG. 4). That is, the current operating speed of the machine may be increased or decreased based upon the acceleration parameter to reach the target speed and continue operation of the machine at the target speed. Once the machine is operating at the target speed, the speed control system may continuously or intermittently (e.g., based upon a predefined time interval) obtain sensor data (i.e., additional or new sensor data) at 510 to determine additional or new operating condition(s) and/or the environmental condition(s). Thus, the speed control system may actively monitor operation of the machine to dynamically adjust the speed of the machine and ensure safe operation of the machine.

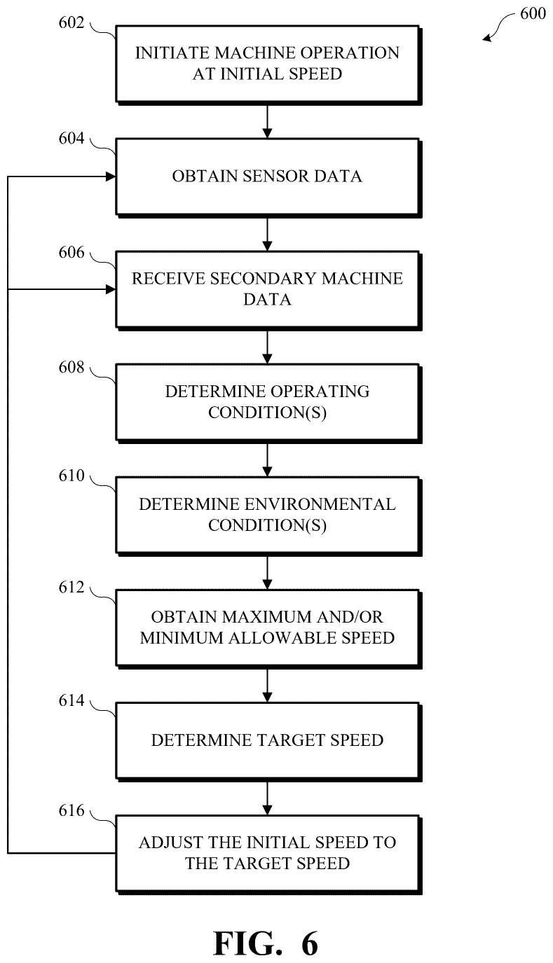

FIG. 6 is a flowchart of a second example of a technique 600 for operating a machine using a speed control system. The technique 600 may be executed using computing devices, such as the systems, hardware, and software described with respect to FIGS. 1A-3. The technique 600 can be performed, for example, by executing by a processor, such as the processor 310 of FIG. 3, a machine-readable program or other computer-executable instructions, such as routines, instructions, programs, or other code, and which may be stored in a memory such as the memory 312 of FIG. 3. The steps, or operations, of the technique 600, or another technique, method, process, or algorithm described in connection with the implementations disclosed herein can be implemented directly in hardware, firmware, software executed by hardware, circuitry, or a combination thereof. The technique 600 can be executed by a speed control system, such as the speed control system 106 of FIGS. 1A-1C or the speed control system 206 of FIGS. 2A and 2B.

For simplicity of explanation, the technique 600 is depicted and described herein as a respective series of steps or operations. However, the steps or operations of the technique 600 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 602, machine operation is initiated at an initial speed. That is, a current speed of the machine is set to the initial speed. The machine is operated to reach the initial speed based on an acceleration parameter, such as the acceleration parameter described above with respect to the technique 400 of FIG. 4. In an example, the speed control system may initiate operation of the machine. The speed control system may commence the operations of the at a default speed, which may be predefined by the speed control system and/or the guidance system or may be input by an operator.

Once operation of the machine is initiated, the speed control system may obtain sensor data, at 604. In an example, the sensor data may be data obtained by one of more sensors of (e.g., included in or associated with) the speed control system.

Once sensor data is obtained, the speed control system may receive secondary machine data at 606. As discussed above, the speed control system may be in communication with additional machinery (e.g., the additional machine 222) such that speed control of the machine may be at least partially based upon operation of the additional machinery. By way of example, the machine may be in communication and with an additional machine, whereby the additional machine may provide data associated with operation of the additional machine to the speed control system. Such data may include, for example, a speed of the additional machine and/or a distance from a target location. However, the data associated with operation of the additional machine may be any data obtained by the speed control system of the machine.

Once the secondary machine data is received, the speed control system may determine one or more operating conditions associated with the machine, at 608. The operating condition(s) may be the same as or similar to the operating conditions discussed above with respect to the technique 400 shown in FIG. 4.

Once the operating conditions are determined, the speed control system may determine one or more environmental conditions, at 610. The environmental condition(s) may be the same as or similar to the environmental conditions discussed above with respect to the technique 400 shown in FIG. 4.

Once the environmental conditions are determined, the speed control system may obtain a maximum allowable speed and/or a minimum allowable speed, at 612. The maximum allowable speed may be a predefined or otherwise set speed in which the machine is unable to surpass. That is, the machine may be prevented from traveling at a speed greater than the maximum allowable speed. Similarly, the minimum allowable speed may be a predefined or otherwise set speed in which the machine in unable to go below. That is, the machine may be prevented from traveling at a speed below the minimum allowable speed. The maximum allowable speed and/or the minimum allowable speed may be input manually by the user (e.g., the operator) or may be predefined settings within the speed control system and/or guidance system of the machine. The maximum allowable speed and/or the minimum allowable speed may be predefined and/or input (e.g., input by the user) for one or more operating situations (e.g., conditions) of the machine. For example, a maximum allowable speed and/or a minimum allowable speed may be predefined and/or input (e.g., input by the user) for one or more of normal operation (e.g., conventional travel along a substantially flat path), crossing a terrace (e.g., when traveling along a sloping terrain), and particular machine operations (e.g., when applying an application to crops, harvesting the crops, when traveling along a particular row of crops in a direction of growth of the crops, when traveling along the particular row of crops in a direction transverse to the direction of growth of the crops, etc.). That is, one or more maximum allowable speeds and/or one or more minimum allowable speeds may be predefined and/or input (e.g., input by the user).

While maximum and minimum allowable speeds are described herein with respect to FIG. 6, maximum and minimum allowable speeds may be implemented in any of the techniques and/or speed control systems shown in FIGS. 1A-7.

Once the maximum allowable speed and/or the minimum allowable speed is obtained, the speed control system may determine a target speed, at 614, in the same or similar manner described with respect to FIG. 4 (e.g., obtaining the target speed from a database and/or calculating the target speed) utilizing the data obtained from the sensor(s) and the data received from the secondary machine. The target speed may be determined based upon one or more of the secondary machine data, the operating condition(s), the environmental condition(s), the maximum allowable speed, and the minimum allowable speed.

In an example, the speed control system may determine that the current speed of the machine is below the maximum allowable speed and that the current ride quality of the machine is acceptable (e.g., minimal or acceptable vibration based upon data obtained from an accelerometer). The speed control system may further determine that the current weather conditions are clear and free of precipitation (e.g., based upon images captured by an image sensor (e.g., camera)). In such a case, the speed control system may determine that the machine may safely operate at an increased speed that may be at or below the maximum allowable speed. Therefore, the speed control system may determine that the target speed should be greater than the current operating speed of the machine (e.g., greater than the current speed).

Conversely, the speed control system may determine that the current speed of the machine is above a minimum allowable speed and that the machine is that the current ride quality of the machine is unacceptable (e.g., vibration of the machine is above a predefined threshold based upon data obtained from an accelerometer). The speed control system may further determine that it is currently raining (e.g., based upon images captured by an image sensor (e.g., camera)). In such a case, the speed control system may determine that the machine may safely not safely operate at the current speed and should operate a speed that is below the current speed, but at or above the minimum allowable speed. Therefore, the speed control system may determine that the target speed should be less than the current operating speed of the machine (e.g., less than the current speed).

Once the target speed is determined, the current speed of the machine may be adjusted by the speed control system to the target speed, at 616. The current speed of the machine may be adjusted based upon an acceleration parameter (e.g., the acceleration parameter of FIG. 4). That is, the current operating speed of the machine may be increased or decreased based upon the acceleration parameter to reach the target speed and continue operation of the machine at the target speed. The acceleration parameter may also be constrained in a similar manner as the speed of the machine. That is, a minimum allowable acceleration rate and/or a maximum allowable acceleration rate may be predefined or input (e.g., input by the user) in a similar manner to the maximum allowable speed and minimum allowable speed at 612. Therefore, a rate of acceleration of the machine may be controlled within a range defined by the minimum allowable acceleration rate and/or the maximum allowable acceleration rate.

Once the machine is operating at the target speed, the speed control system may continuously or intermittently (e.g., based upon a predefined time interval) obtain sensor data (i.e., additional or new sensor data) at 604 and/or receive data (i.e., additional or new data) from the secondary machine data at 606 to determine additional or new operating condition(s) and/or the environmental condition(s). Thus, the speed control system may actively monitor operation of the machine and the secondary machine to dynamically adjust the speed of the machine and ensure safe operation of the machine.

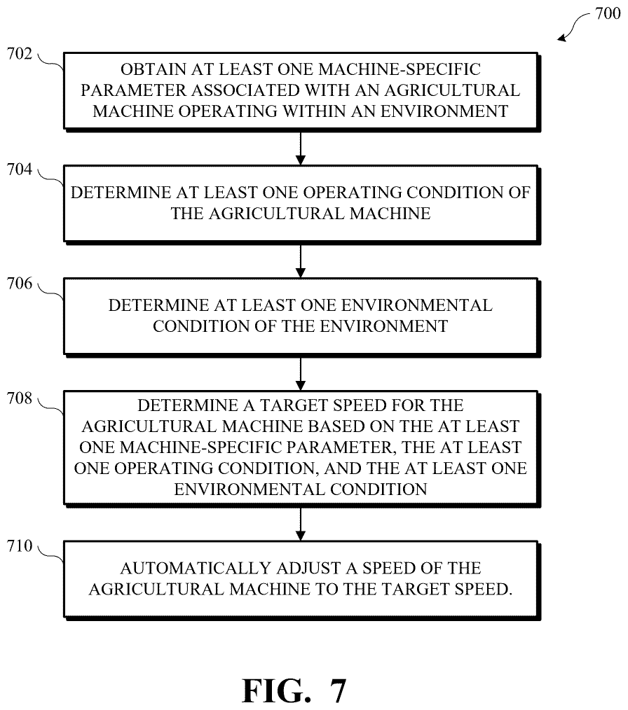

FIG. 7 is a flowchart of a second example of a technique 700 for operating an agricultural machine within an environment using a speed control system. The technique 700 may be executed using computing devices, such as the systems, hardware, and software described with respect to FIGS. 1A-3. The technique 700 can be performed, for example, by executing by a processor, such as the processor 310 of FIG. 3, a machine-readable program or other computer-executable instructions, such as routines, instructions, programs, or other code, and which may be stored in a memory such as the memory 312 of FIG. 3. The steps, or operations, of the technique 700, or another technique, method, process, or algorithm described in connection with the implementations disclosed herein can be implemented directly in hardware, firmware, software executed by hardware, circuitry, or a combination thereof. The technique 700 can be executed by a speed control system, such as the speed control system 106 of FIGS. 1A-1C or the speed control system 206 of FIGS. 2A and 2B.

For simplicity of explanation, the technique 700 is depicted and described herein as a respective series of steps or operations. However, the steps or operations of the technique 700 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 702, the speed control system may obtain at least one machine-specific parameter associated with the agricultural machine within the environment. The at least one machine-specific parameter may be any of the machine-specific parameters described above with respect FIGS. 1A-6. For example, the speed control system may obtain a wheelbase and/or a center of gravity of the machine based upon predefined machine specifications (e.g., a length, height, width, weight, etc.).

Once the speed control system obtains the at least one machine-specific parameter, the speed control system may determine, at 704, at least one operating condition of the agricultural machine. The at least one operating condition may be any of the operating conditions described above with respect FIGS. 1A-6. For example, the speed control system may determine a ride quality of the machine, a current speed of the machine, an orientation of the machine, a location of the machine, or a combination thereof.

Once the speed control system determines the at least one operating condition, the speed control system may determine, at 706 at least one environmental condition of the environment (e.g., the environment in which the machine is currently operating). The at least one environmental condition may be any of the environmental conditions described above with respect FIGS. 1A-6. For example, the speed control system may determine terrain features (e.g., anomalies, curvature, grade, etc.) of upcoming terrain with respect to a direction of travel of the machine and/or weather conditions (e.g., rain, wind, visibility, etc.)

Once the speed control system determines the at least one environmental condition, the speed control system may determine a target speed, at 708. The target speed may be based on the at least one machine-specific parameter, the at least one operating condition, and the at least one environmental condition. In some implementations, the target speed may be based on only a portion of the at least one machine-specific parameter, the at least one operating condition, and the at least one environmental condition. In an example, the target speed may be determined based on the at least one operating condition and the at least one environmental condition, but not the at least one machine-specific parameter. The target speed may be determined in the same or similar manner described with respect to FIG. 4 (e.g., obtaining the target speed from a database and/or calculating the target speed) utilizing the machine-specific parameter(s) obtained and the data obtained from the sensor(s).

Once the target speed is determined, the speed control system may automatically adjust a speed of the agricultural machine to the target speed, at 710. The speed of the agricultural machine may be adjusted based upon an acceleration parameter (e.g., the acceleration parameter of FIG. 4). That is, the speed control system may increase or decrease a speed of the agricultural machine, based upon the acceleration parameter, to match the target speed.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A method for controlling a speed of an agricultural machine operating within an environment, the method comprising:
obtaining at least one machine-specific parameter associated with the agricultural machine;
determining at least one operating condition of the agricultural machine;
determining at least one environmental condition of the environment;
determining a target speed for the agricultural machine based on the at least one machine-specific parameter, the at least one operating condition, and the at least one environmental condition; and
adjusting the speed of the agricultural machine to the target speed.

2. The method of claim 1, wherein the at least one machine-specific parameter includes at least one of a wheelbase of the agricultural machine or a center of gravity of the agricultural machine, and wherein at least one of the wheelbase or the center of gravity changes during operation of the agricultural machine.

3. The method of claim 1, wherein the at least one operating condition includes at least one of a current speed of the agricultural machine, a maximum possible speed of the agricultural machine, a position of the agricultural machine, an orientation of the agricultural machine, a ride quality of the agricultural machine, a load of the agricultural machine, or a mechanical issue of the agricultural machine.

4. The method of claim 1, wherein the at least one operating condition includes a power capacity of the agricultural machine, the power capacity being associated with an ability of the agricultural machine to increase speed or decrease speed to reach the target speed.

5. The method of claim 1, wherein the at least one operating condition includes an off-track error that is determined based on a distance between a current position of the agricultural machine and a desired position of the agricultural machine along a pre-defined path of the agricultural machine.

6. The method of claim 1, wherein the at least one environmental condition includes at least one of a terrain feature or a weather condition;
wherein the terrain feature includes at least one of bumpiness of a terrain of the environment, a slope of the terrain, or a curvature of the terrain; and
wherein the weather condition includes at least one of precipitation, wind, visibility, temperature, or sunlight.

7. The method of claim 1, wherein determining the target speed is further based on historical operating data associated with the agricultural machine or another agricultural machine in the environment.

8. The method of claim 1, wherein determining the target speed is further based on a terrain map corresponding to the environment.

9. The method of claim 1, further comprising:
determining at least one of a location or a speed of an additional agricultural machine within the environment,
wherein the target speed is further based on at least one of the location or the speed of the additional agricultural machine.

10. The method of claim 1, further comprising:
obtaining at least one of a maximum allowable speed or a minimum allowable speed, wherein the target speed is at or below the maximum allowable speed and at or above the minimum allowable speed.

11. A system for controlling a speed of an agricultural machine operating within an environment, the system comprising:
one or more memories; and
one or more processors, the one or more processors configured to execute instructions stored in the one or more memories to:
obtain at least one machine-specific parameter associated with the agricultural machine;
determine at least one operating condition of the agricultural machine;
determine at least one environmental condition of the environment;
determine a target speed for the agricultural machine based on the at least one machine-specific parameter, the at least one operation condition, and the at least one environmental condition; and
adjust the speed of the agricultural machine to the target speed.

12. The system of claim 11, wherein the at least one machine-specific parameter includes at least one of a wheelbase of the agricultural machine or a center of gravity of the agricultural machine, and wherein at least one of the wheelbase or the center of gravity changes during operation of the agricultural machine.

13. The system of claim 11, wherein the at least one operating condition includes at least one of a current speed of the agricultural machine, a maximum possible speed of the agricultural machine, a position of the agricultural machine, an orientation of the agricultural machine, a ride quality of the agricultural machine, a load of the agricultural machine, or a mechanical issue of the agricultural machine.

14. The system of claim 11, wherein the at least one operating condition includes a power capacity of the agricultural machine, the power capacity being associated with an ability of the agricultural machine to increase speed or decrease speed to reach the target speed.

15. The system of claim 11, wherein the at least one environmental condition includes at least one of a terrain feature or a weather condition;
wherein the terrain feature includes at least one of bumpiness of a terrain of the environment, a slope of the terrain, or a curvature of the terrain; and
wherein the weather condition includes at least one of precipitation, wind, visibility, temperature, or sunlight.

16. The system of claim 11, wherein the one or more processors are further configured to execute instructions stored in the one or more memories to:
determine at least one of a location or a speed of an additional agricultural machine within the environment,
wherein the target speed is further based on at least one of the location or the speed of the additional agricultural machine.

17. The system of claim 11, wherein the one or more processors are further configured to execute instructions stored in the one or more memories to:
obtain at least one of a maximum allowable speed or a minimum allowable speed, wherein the target speed is at or below the maximum allowable speed and at or above the minimum allowable speed.

18. One or more non-transitory computer readable media storing instructions operable to cause one or more processors to perform operations for controlling a speed of an agricultural machine operating within an environment, the operations comprising:
obtaining at least one machine-specific parameter associated with the agricultural machine;
determining at least one operating condition of the agricultural machine;
determining at least one environmental condition of the environment;
determining a target speed for the agricultural machine based on the at least one machine-specific parameter, the at least one operation condition, and the at least one environmental condition; and
adjusting the speed of the agricultural machine to the target speed.

19. The one or more non-transitory computer readable media of claim 18, wherein the at least one operating condition and the at least one environmental condition are based on data obtained by one or more sensors of the agricultural machine.

20. The one or more non-transitory computer readable media of claim 19, wherein the one or more sensors include at least one of a Global Positioning System (GPS) sensor, an Inertial Measurement Unit (IMU) sensor, a light detection and ranging (LiDAR) sensor, and a camera.
